(19) United States
(12) Patent Application Publication
(10) Pub. No.: US 2026/0010891 A1
(43) Pub. Date: Jan. 8, 2026

(54) TOKENIZATION THROUGH OFFLINE CONTACTLESS TAP

(71) Applicant: AMERICAN EXPRESS TRAVEL RELATED SERVICES COMPANY, INC., New York, NY (US)

(72) Inventor: Manik BISWAS, Burgess Hill (GB)

(73) Assignee: AMERICAN EXPRESS TRAVEL RELATED SERVICES COMPANY, INC., New York, NY (US)

(21) Appl. No.: 18/762,236

(22) Filed: Jul. 2, 2024

(51) Int. Cl. G06Q 20/34; G06Q 20/36; G06Q 20/40

(52) U.S. Cl. CPC G06Q 20/351; G06Q 20/36; G06Q 20/4097

(57) ABSTRACT

Disclosed herein are system, method, and computer program product embodiments for tokenization in an offline environment. A tokenization system may initiate a tokenization transaction with a payment card. The tokenization system may acquire from the payment card a token primary account number, an account specific key, and tokenization data associated with the tokenization transaction. The tokenization system may store in a digital wallet an association between the token primary account number and a digitized version of the payment card.

### TECHNICAL FIELD

Aspects relate to systems and methods for offline tokenization.

### BACKGROUND

Payment card accounts are widely used by customers to pay for in-store purchase transactions, online shopping transactions, bill payments, and other purposes. Chip cards can provide substantial protection during in-store purchases. Tokenization systems can provide similar protections for online transactions and for transactions using electronic devices.

Tokenization is a process where a new primary account number (PAN) is generated or derived with certain domain controls and is tightly attached to a funding account. The tokenization process was adopted to reduce fraud and provide better user experience. Typically, the tokenization process starts by a service contacting an issuing system (e.g., a bank) or an issuing network to issue a token and to attach the token to the funding source. However, the tokenization process suffers from the technical challenge of requiring online connectivity. Without having online connection to the issuing system or the issuing network, a token cannot be obtained and hence cannot be used.

### SUMMARY

Disclosed herein are system, apparatus, device, method and/or computer program product embodiments, and/or combinations and sub-combinations thereof, for offline tokenization.

In some embodiments, a method may include initiating in an offline environment a tokenization transaction with a payment card, acquiring from the payment card, a token primary account number (PAN), an account specific key, and tokenization data associated with the tokenization transaction initiated by the user device and storing in a digital wallet of a user device an association between the token PAN and a digitized version of the payment card.

In some embodiments, a payment card may include a microchip. The microchip can receive a request for a tokenization transaction from a user device. The request is sent in an offline environment. In response to receiving the tokenization transaction, the microchip can generate tokenization data. The tokenization data comprises at least a token primary account number (PAN) and an account specific key.

In some embodiments, a system includes a memory and at least one processor coupled to the memory. The at least one processor is configured to initiate a tokenization transaction with a payment card in an offline environment, acquire, from the payment card, a token primary account number (PAN), an account specific key, and tokenization data associated with the tokenization transaction initiated by the user device. The at least one processor is further configured to store, in a digital wallet of the user device, an association between the token PAN and a digitized version of the payment card.

Certain aspects of the disclosure have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the art to make and use the aspects.

FIG. 1A is a block diagram of an environment for a tokenization system, in accordance with an embodiment of the present disclosure.

FIG. 1B is a block diagram of the tokenization system, in accordance with an embodiment of the present disclosure.

FIG. 2 is a flow diagram for a tokenization process, in accordance with an embodiment of the present disclosure.

FIG. 3A is a swim lane diagram for a tokenization process using a host application, in accordance with an embodiment of the present disclosure.

FIG. 3B is a swim lane diagram for a tokenization process using a digital wallet, in accordance with an embodiment of the present disclosure.

FIG. 4 is an example method for a tokenization process, in accordance with an embodiment of the present disclosure.

FIG. 5 is an example method for a tokenization process, in accordance with an embodiment of the present disclosure.

FIG. 6 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Aspects of the present disclosure relate to a system for performing an offline tokenization process. In particular, the present disclosure relates to performing a tokenization process for a payment card. The tokenization process may be triggered by a user device in communication with the payment card without online connectivity (e.g., in an offline environment and without connection to a host system).

In some tokenization processes, a token and associated data may be obtained from an issuer system of the payment card or an issuer network before being added to a digital wallet of the user device. During the tokenization process, funding account details are captured by the user device and relayed to the issuer system (e.g., issuing host) or the issuer network with a request for a new token. The tokenization process relies on a backend of the issuer system or the issuer network that can receive and service the request by generating the new token and associated data. The backend of the issuer system or issuer network may send the new token and associated data to the user device. The user device may decipher the new token and associated data and add them to the digital wallet that can be used for payment processing.

As described in the background section, this process relies on an online connectivity with the issuer system or the issuer network. However, online connectivity may not be available when a customer desires to add the payment card to the digital wallet of the user device.

Provided herein is a tokenization system configured to tokenize a funding source (e.g., a payment card) into a user device without connecting to a network or contacting the issuer system or issuer network. In some aspects, the payment card may be tokenized into the digital wallet of the user device. A customer may initialize the tokenization process by performing a contactless transaction with the payment card. Through the tokenization process, the user device may obtain a token and associated data from the payment card. The token may be added to the digital wallet securely in an offline environment. This will eliminate the need of online connectivity or connecting to backend systems during the process.

In some aspects, the tokenization system has the advantage of allowing tokenization process even when there is no connection with a host system or issuer system. A payment card may added to the digital wallet without delays caused by lack of a connection to the host system or issuer system. By eliminating the need to connect to the host system during the tokenization process, the present disclosure improves computer systems by allowing tokenization processes to occur locally on a user mobile device without having to access an online connection to the host system or issuing network. Whereas previously, a user may not be able to add and use the payment card if a connection with the host system is not available, aspects of the present disclosure improve upon prior art systems by creating a local personal area network between a mobile device and a payment card which allows for the tokenization of payment cards without having to access a remote system or network and without delays due to connection problems.

The present disclosure provides an improvement in the technologies of electronic devices and mobile payments by providing an improved tokenization process that solves the above-noted technological problems. In addition, the tokenization process may be performed much faster because the tokenization process is not tied to a connection speed of the network or the server status (e.g., server availability). Thus, delays due to internet issues, server downtime, or firewall restrictions are eliminated.

Further, the present disclosure solves the technological problem of limited availability of a private network. The user is not required to connect to a public network such as a public WiFi or other unsecured networks. By avoiding the connection to unsecured networks, the risk of hacks, unauthorized access, and cyberattacks is reduced. Thus, the functionality of the electronic device is also improved by improving the security of the electronic device.

In addition, the tokenization process may not be applied mentally, it requires at least a processor to acquire and store a token primary account number in a digital wallet. It is not practical or feasible to acquire the token primary account number and associated information by a human mind because the associated information such as the account specific key (AES) are generated using advanced encryption standard.

Various embodiments of these features will now be discussed with respect to the corresponding figures.

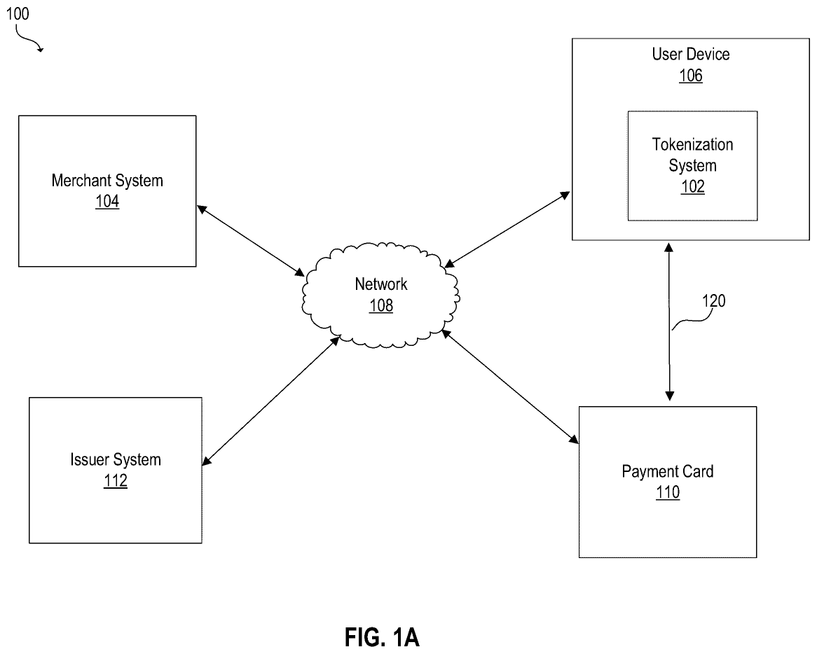

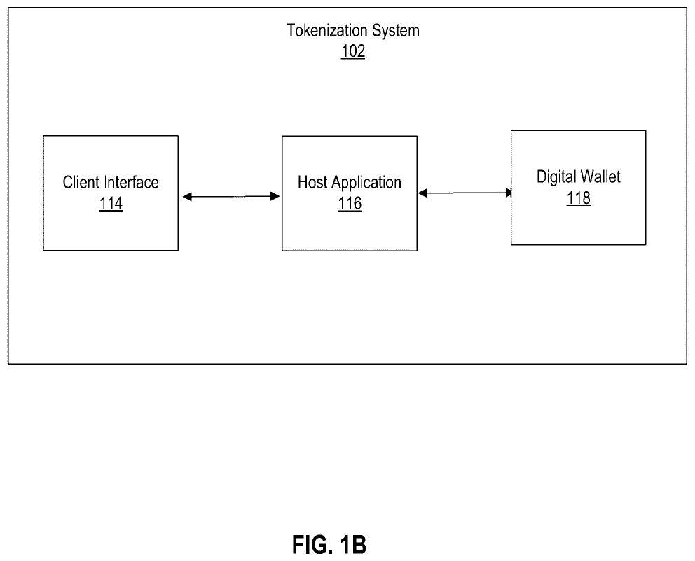

FIG. 1A is a block diagram of an environment 100 for a tokenization system 102, in accordance with an embodiment of the present disclosure. Environment 100 may include a merchant system 104, a user device 106, a network 108, a payment card 110, and an issuer system 112.

In some aspects, tokenization system 102 may be implemented using user device 106. Tokenization system 102 may acquire or generate a token for a payment account (e.g., payment card 110). The token may be stored in a digital wallet of user device 106. The token may include an identifier for the payment account that is a substitute for an account identifier, such as a primary account number (PAN). For example, the token may include a series of numeric and/or alphanumeric characters that may be used as a substitute for an original account identifier. For example, a token PAN “5800 0000 0001 0002” may be used in place of a PAN “5804 7000 1234 4614.” In some aspects, the token may be used in place of the PAN to initiate, authorize, settle, or resolve a payment transaction. In some aspects, the token PAN may conform to account identifiers used in existing payment processing networks.

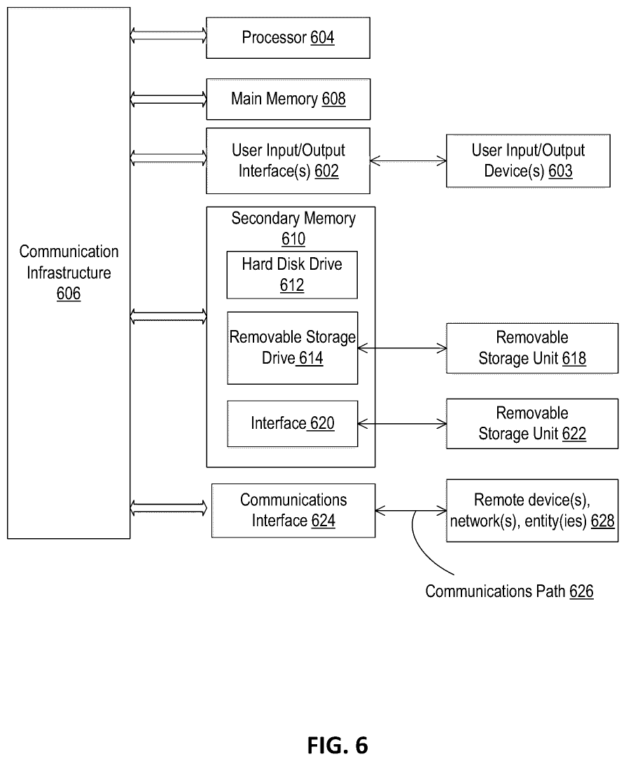

User device 106 may be any variety of devices, such as a smart phone, a cellular phone, a personal digital assistant, a tablet computer, a notebook computer, a laptop computer, or a combination thereof. For example, user device 106 may be a computer system such as computer system 600 described with reference to FIG. 6.

User device 106 may initiate the tokenization process with payment card 110. To initiate the tokenization process, user device 106 may open a communication channel 120 with payment card 110. Communication channel 120 may be a contactless channel. Communication channel 120 may be a near field communication (NFC) channel such as a wireless radio frequency (RF) channel. Once communication channel 120 is established between payment card 110 and tokenization system 102, tokenization system 102 may output a series of application protocol data units (APDUs) to read out details from payment card 110. The APDUs can be proprietary or standard. The details from payment card may include a name of the cardholder, an expiry data, and the token PAN and associated data as further described below.

Payment card 110 may be a debit card, a credit card or a charge card, a pre-paid payment card, a gift card, a transit card, or a store card. In some aspects, payment card 110 may be issued by issuer system 112. Payment card 110 may include an integrated circuit (IC). The IC may store data and communicate with other devices (e.g., user device 108, merchant system 104) via NFC. An example of IC payment card standard is referred to as “EMV.” For example, payment card 110 may include one or more microchips. The one or more microchips may be configured to emit, via one or more antennas, electromagnetic waves for contactless communications with user device 108 and a point of sale (POS) terminal associated with merchant system 104. Data stored in payment card 110 may include information used to authenticate, authorize, and process transactions and to process the tokenization request as described further below.

After receiving the tokenization request from tokenization system 102, payment card 110 may authenticate tokenization system 102 using keys and/or certificates. The keys and/or certificates may be provided by issuer system 112 to payment card 110 and tokenization system 102. Payment card 110 may store the keys/certificates. The keys may include a public key and a private key. In some aspects, the public key may be shared using a certificate.

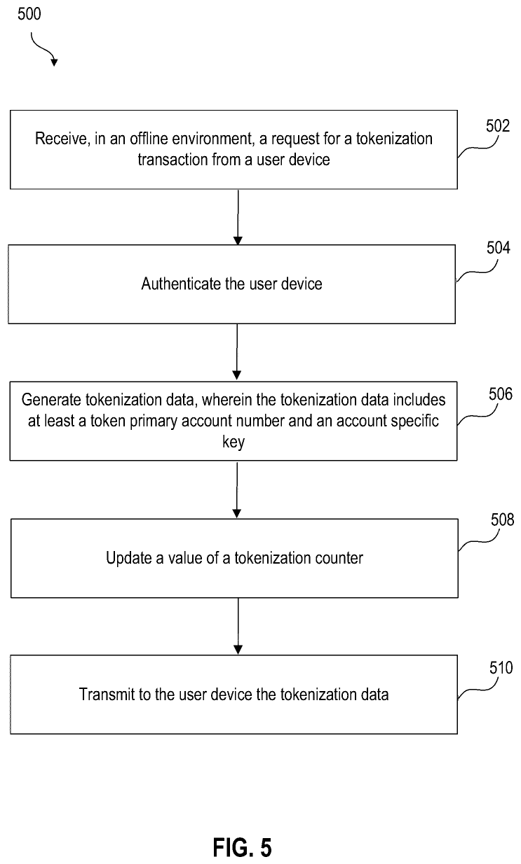

Upon authentication, payment card 110 may generate or identify a new token PAN and associated data. Payment card 110 may transmit the token PAN and associated data to tokenization system 102. The token PAN and associated data may be generated using multiple techniques. In some aspects, payment card 110 may use a different PAN sequence number to differentiate the token PAN from previously generated token for different devices. Token generation is further described in relation with FIG. 5.

In addition to the token PAN, payment card 110 may transmit the associated data. The associated data may include track 2 data, an account specific key (e.g., a payment secret key), offline data authentication keys and certificates, and other metadata. In some aspects, track 2 data may include information used in processing card transactions. The track 2 data can include a card expiration date and other discretionary data. In some aspects, the offline data authentication keys and certificates may include a set of asymmetric key pair and certificates that are used in the offline data authentication process as outlined within EMV® specifications. Among these, one keyset is unique per PAN. The unique keyset may be used while issuing the certificate as well. The other metadata may include data used by a payment system (e.g., digital wallet) to operate. For example, the metadata may include an application transaction counter (ATC), various offline counters, and the like. The ATC provides a sequential reference to each transaction. A duplicate ATC, a decrease in ATC or a large jump in ATC values may indicate data copying or other fraud to issuer system 112. The ATC is maintained by a chip card application (e.g., incremented by the chip) and output to tokenization system 102 with the token PAN.

In some aspects, payment card 110 may derive a new account specific key. The account specific key can be derived based on the token PAN and the token PAN sequence number following a standard EMV process as further described in relation with FIG. 5.

In addition to generating the token PAN and associated data, payment card 110 may secure the token number and the associated data under the secure channel keys and then transferred to user device 106 through APDU exchange.

In addition to generating and transmitting the token PAN and associated data, payment card 110 may implement a tokenization counter. A tokenization counter value may represent a total number of tokenization transactions performed by payment card 110. The tokenization counter may be reset by issuer system 112 through EMV scripting process.

After receiving the token PAN and associated data from card payment 110, user device 106 may associate the token PAN and the associated data with a digitized version of payment card 110 in a digital wallet. In some aspects, the customer may initiate a transaction from the digital wallet. The transaction may also refer to a purchase at an online merchant, a payment at a merchant point of sale (POS) using the digital wallet.

Issuer system 112 may issue payment card 110. Issuer system 112 may store a data set for each customer (e.g., for each cardholder) including the brand of the card, account number, card parameters, such as spending limits. As discussed above, issuer system 110 may generate the keys and certificates and transmit the keys and the certificates to payment card 110 and user device 106. Issuer system 104 may be a computer system such as computer system 600 described with reference to FIG. 6. Issuer system 112 may transmit the keys and the certificates to tokenization system 102 and payment card 110 via network 108 prior to the tokenization process.

Merchant system 104 may be configured to facilitate in-person and/or online transactions. Merchant system 104 may be a computer system such as computer system 600 described with reference to FIG. 6. Merchant system 104 may include input I/O devices, one or more processors, and a memory such as computer readable media. In some aspects, merchant system 104 may include one or more POS terminals, cellular phones, personal computers, tablet, hand-held specialized readers, and the like. The POS may include a reader. The reader may include any suitable contact or contactless mode of operations. For example, exemplary card readers may include radio frequency (RF) antennas, optical scanners, bar code readers, or magnetic stripe readers to interact with user device 106. Merchant system 104 may be associated with a merchant. Merchant system 104 may determine a transaction value (e.g., total value of the merchandise or service provided) and acquire payment information from the customer. For example, a user may present the digitized version of payment card 110 for a payment in a transaction at POS system associated with merchant system 104. For the example, the user may hold user device 108 within a few inches from the POS terminal of merchant system 104. User device 106 may wirelessly communicate the token PAN to the POS terminal of merchant system 104. This may occur when user device 106 is in proximity to POS terminal using NFC or radio frequency identification (RFID) technology. For example, user device 106 may communicate the token PAN from the digital wallet stored on user device 106.

After acquiring the account information, merchant system 104 may send a request for authorizing a transaction to issuer system 112 in order to authenticate that the consumer is the rightful owner of a payment account associated with the data transmitted by the consumer. In some aspects, merchant system 104 may determine that the account information includes a token. Based on the token, merchant system 104 may identify issuer system 112 and send the request to the appropriate issuer system. For example, merchant system 104 may query a table or a database to identify the issuer associated with the account number. In response to receiving the request, issuer system 112 may authorize the transaction. Merchant system 104 may send transaction data with the request for authorization. The transaction data may include the transaction value and the token.

After receiving the authorizing request from merchant system 104, issuer system 112 (or a financial entity associated with issuer system 112) may determine if the funds are available in the user account for the transaction and if the transaction information meets other limits by comparing the transaction information associated with the token, the user account associated with the token, or other limits. If the transaction information does not meet one or more of the limit, issuing system 112 may deny the truncation. Issuing system 112 may send a notification of approval or denial of the transaction back to merchant system 104, which either allows or denies the transaction as described above. Merchant system 104 may output an approval or rejection on a display of the merchant system 104. For example, merchant system 104 may trigger a printing device to print a receipt indicating that the total value is paid. Merchant system 104 may also generate and transmit an electronic receipt to user device 106 and/or an email address associated with the customer.

Merchant system 104, user device 106, and issuer system 112 may communicate via network 108. Network 108 may be a telecommunications network, such as a wired or wireless network. Network 108 can span and represent a variety of networks and network topologies. For example, network 108 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in network 108. Cable, Ethernet, digital subscriber line (DSL), fiber optic lines, fiber to the home (FTTH), and plain old telephone service (POTS) are examples of wired communication that may be included in network 108. Further, network 108 can traverse a number of topologies and distances. For example, network 108 can include a direct connection, personal area network (PAN), local area network (LAN), metropolitan area network (MAN), wide area network (WAN), or a combination thereof.

FIG. 1B is a block diagram of tokenization system 102, in accordance with an embodiment of the present disclosure. Tokenization system 102 may include a client interface 114, a host application 116, and a digital wallet 118.

In some embodiments, user device 106 may be configured to download and/or install a software application to initiate offline tokenization processes. For example, user device 106 may install host application 116 from issuer system 112 and/or an application marketplace or application exchange. The user may initiate the tokenization process using client interface 114.

Client interface 114 may be an interface for presenting and/or receiving information to/from a user (e.g., a consumer). The interface may be a communication interface such as a command window, a web browser, a display, and/or any other type of interface. Other software, hardware, and/or interfaces may be used to provide communication between the user and tokenization system 102.

Host application 116 may initiate a user authentication and may manage the security of user device 106 side. For example, host application 116 may request a user name and password associated the user. In some aspects, the user name and password may be managed by issuer system 112. In some aspects, host application 116 may implement a two-factor authentication.

In some aspects, host application 116 may be an issuer application or a white labelled application. Host application 116 may be an application within a secure element, within a trusted execution environment (TEE), or software based. In some aspects, function performed by host application 116 may be performed by digital wallet 118. Digital wallet 118 may refer to a client (front-end) side or may refer to the entirety of a wallet solution, including back-end systems utilized to initiate and/or complete financial transactions. Digital wallet 118 may correspond to a blockchain wallet, an asset account, a financial account, a central bank digital currency (CBDC) wallet, a government and/or state issued digital wallet, a private wallet, a business wallet, and/or other digital accounts capable of settling transactions.

As described previously herein, host application 116 may open a communication channel with payment card 110. In addition (e.g., in parallel), host application 116 may open another secure communication channel with digital wallet 118.

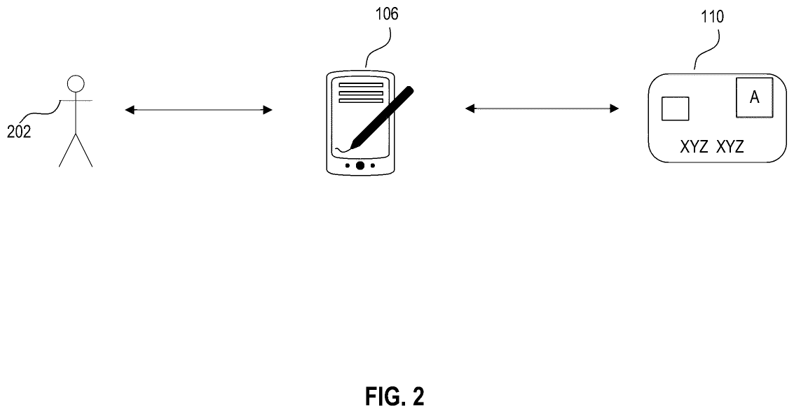

FIG. 2 is a flow diagram for a tokenization process, in accordance with an embodiment of the present disclosure. A user 202 may interact with user device 106 to initiate a tokenization process. For example, user 202 may desire to add payment card 110 to the digital wallet of user device 106. For example, user 202 may interact with user device 106 to launch host application 116 to load payment card 110 to digital wallet 118. Once launched, host application 116 may display client interface 112 on a display screen of user device 106. User 202 may authenticate to host application 116 by entering user credentials such as a username and a password or a personal identification number (PIN). Upon successful user authentication, user 202 may select one or more payment accounts from a list of payment accounts available in host application 116. After selecting the desired payment account, user 202 may present payment card 110 associated with the selected payment account to user device 106. For example, client interface 114 may display a message to user 202 to place payment card 110 within a few inches of user device 106. After the data from payment card 110 is transferred to host application 116, client interface 114 may display another message indicating to user 202 that user 202 may pull the card away. The data transferred to host application 116 is further described with relation to FIG. 5. In addition, after the token is added to digital wallet 118, a notification may be output to user 202 via client interface 114.

In some aspects, user 202 may use the process described above to re-tokenize payment card 110 in the case the security of the token stored in digital wallet 118 was compromised.

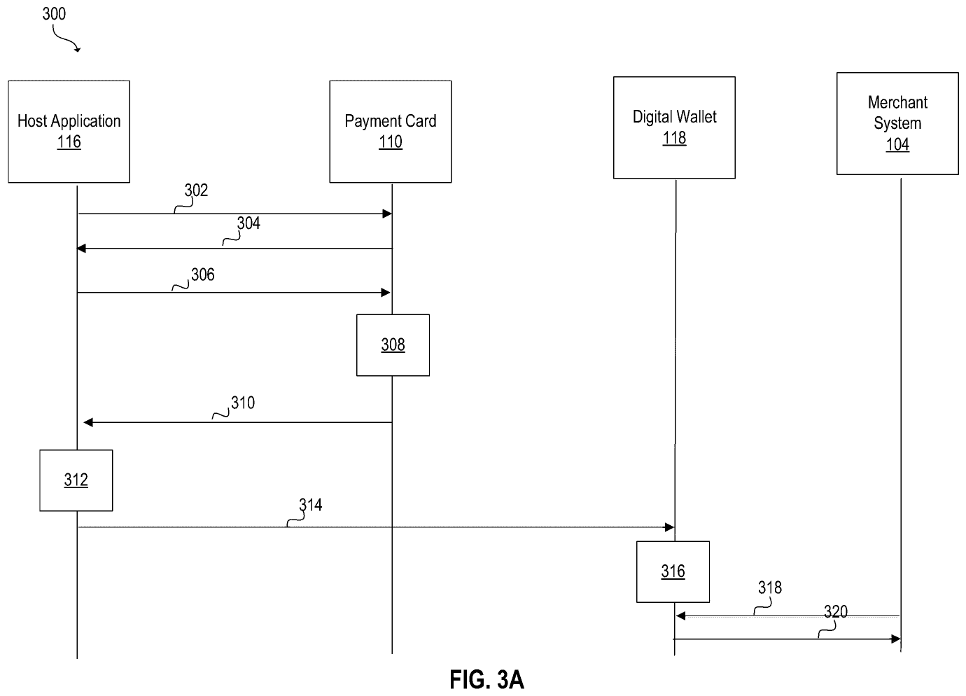

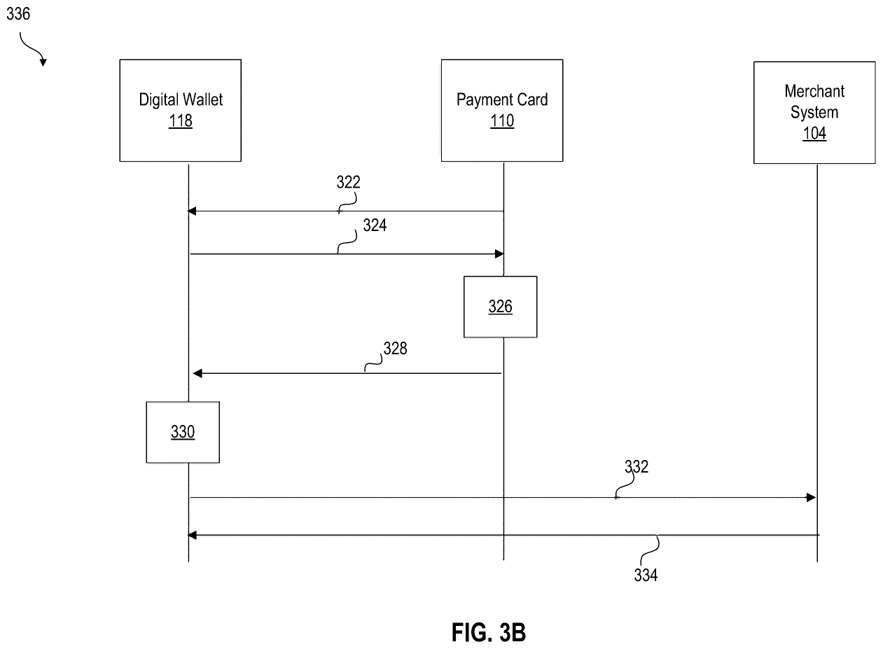

FIG. 3A is a swim lane diagram 300 for a tokenization process using host application 116, in accordance with an embodiment of the present disclosure. Swim lane diagram 300 shows examples of communications between host application 116, payment card 110, digital wallet 118, and merchant system 104. Communications between host application 116, payment card 110, and digital wallet 118 may be in an offline environment.

At 302, host application 116 may open a communication channel with payment card 110.

At 304, as described above, user device 106 and payment card 110 may authenticate each other before the tokenization process starts. Multiple authenticating techniques may be implemented. In some aspects, payment card 110 can be equipped with a specific tokenization key during the initial issuance process (e.g., generated by issuer system 112). The purpose of the tokenization key is to provide the ability to establish a secure channel with host application 116 when desired (e.g., after receiving a request from host application 116). In addition or alternatively, payment card 110 and host application 116 may authenticate each other using a trusted certificate. In some aspects, a root of trust can be personalized within payment card 110 and the same can be provided to host application 116 through a separate channel (e.g., via issuer system 112). In some aspect, host application 116 may implement a PIN verification process. For example, host application 116 may prompt the user for a PIN associated with payment card 110. The entered PIN may be in turn verified against security information that was transmitted during the issuance process. This process adds an additional layer of security to the tokenization process.

At 306, host application 116 may transmit the keys and/or certificates to complete the authentication process. Host application 116 may transmit other information based on the authentication method implemented.

At 308, in response to verifying the information transmitted by host application 116, payment card 110 may generate the token PAN and associated data as further described in relation with FIG. 5.

At 310, payment card 110 may transmit the token PAN and associated data to host application 116.

At 312, host application 116 may identify a digital wallet associated with the electronic device. For example, if user device 106 includes one or more digital wallets (e.g., a business digital wallet and a personal digital wallet), host application 116 may identify the digital wallet that corresponds to payment card 110. In addition, host application 116 may perform additional processing on the acquired data (e.g., decipher the acquired data).

At 314, host application 116 outputs the acquired token data to digital wallet 118.

At 316, digital wallet 118 may prepare the token. For example, digital wallet 118 may associate the token PAN with payment card 110. The digitized version of payment card 110 may be used in a transaction with merchant system 104.

At 318, digital wallet 118 may receive transaction data from merchant system 104.

At 320, in response to receiving the transaction data, digital wallet 118 may output the token PAN 110.

FIG. 3B is a swim lane diagram 336 for a tokenization process using digital wallet 118, in accordance with an embodiment of the present disclosure. Swim lane diagram 336 shows examples of communications between payment card 110, digital wallet 118, and merchant system 104. Communications between payment card 110 and digital wallet 118 may be in an offline environment.

At 322, payment card 110 may output to digital wallet 118 the keys and/or certificates to authenticate each other.

At 324, digital wallet 118 may transmit the keys and/or certificates to payment card 110.

At 326, payment card 110 may verify the keys and/or certificates. In response to verifying the keys and/or certificates, payment card 110 may generate the token PAN and associated data as further described in relation with FIG. 5.

At 328, payment card 110 may output the token PAN and associated data to digital wallet 118.

At 330, digital wallet 118 may associate the token PAN and associated data with the digitized version of payment card 110.

At 332, user device 106 may be presented to a contactless reader associated with merchant system 104 (such as a POS terminal).

At 334, an interrogation process between digital wallet 118 and the contactless payment device ensue. Digital wallet 118 and the contactless reader exchange data associated with a transaction (e.g., a purchase). Digital wallet 118 may output the token PAN to merchant system 104 using NFC communication.

### Methods of Operation

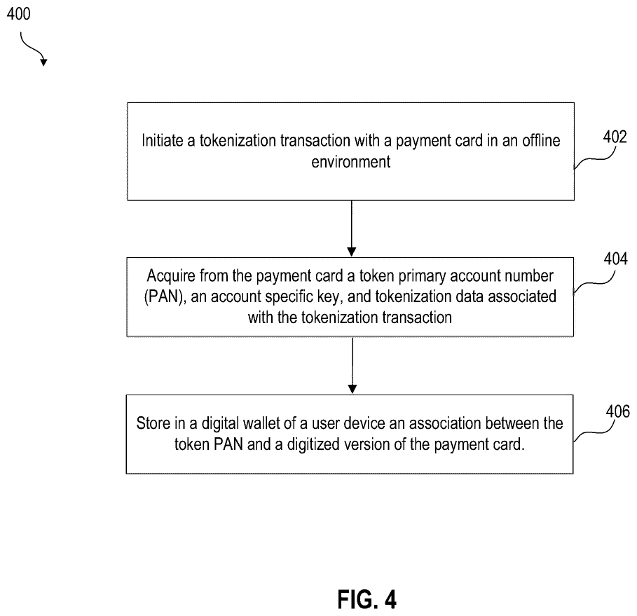

FIG. 4 is an example method 400 for a tokenization process, in accordance with an embodiment of the present disclosure.

Method 400 may be performed as a series of steps by a computing unit such as a processor. For example, method 400 may be implemented by tokenization system 102 and/or computer system 600 of FIG. 6. Method 400 shall be described with reference to FIG. 1A, however, method 400 is not limited to that example embodiment.

At 402, tokenization system 102 may initiate a tokenization transaction with a payment card in an offline environment (i.e., without connecting to a server or payment card issuer). In some aspects, tokenization system 102 and payment card 110 may mutually authenticate each other. After authentication, tokenization system 102 may establish a communication channel between the user device and the payment card. In some accepts, the communication channel is established via near field communication.

In some aspects, tokenization system 102 may establish an additional communication channel with the digital wallet.

At 404, tokenization system 102 may acquire from the payment card a token PAN, an account specific key, and tokenization data associated with the tokenization transaction. In some aspects, the tokenization data includes a PAN sequence number. The PAN sequence number and the account specific key may be generated by payment card 110. As described previously, the PAN sequence number is a unique identifier associated with each request for a tokenization transaction.

In some aspects, a plurality of token PANs may be stored on a microchip of payment card 110. The microchip of payment card 110 may select the token PAN from the plurality of token PANs.

At 406, tokenization system 102 may store in a digital wallet of a user device an association between the token PAN and a digitized version of the payment card.

It is to be appreciated that not all steps may be needed to perform the disclosure provided herein. Further, some of the steps may be performed simultaneously, or in a different order than shown in FIG. 4, as will be understood be a person of ordinary skill in the art.

FIG. 5 is an example method 500 for a tokenization process, in accordance with an embodiment of the present disclosure. Method 500 may be performed as a series of steps by a computing unit such as a processor. For example, method 500 may be implemented by a microchip of payment card 110. Method 500 shall be described with reference to FIG. 1A, however, method 500 is not limited to that example embodiment.

At 502, payment card 110 may receive a request for a tokenization transaction from a user device. The request is sent by the user device in an offline environment without connection to a host system (e.g., via NFC).

At 504, payment card 110 may authenticate the user device (e.g., user device 106). To authenticate the user device, the microchip of payment card 110 may perform a validation process using a common key with the user device. Issuer system 112 may provide the common key to payment card 110 and tokenization system 102 during the issuance of payment card 110.

At 506, payment card 110 may generate tokenization data. The tokenization data includes at least a token PAN and an account specific key. The tokenization data may also include an application transaction counter and an offline data authentication key.

In some aspects, payment card 110 may identify the token PAN from a pre-defined set of PANs. The set of PANs can be personalized upfront (e.g., before the tokenization process) and refreshed via EMV scripting process. For example, during the issuance of payment card 110 issuer system 112 may load payment card 110 with the pre-defined set of PANs. During each tokenization process, a token PAN from the pre-defined set of PANs may be identified and used. In some aspects, each different tokenization process may use a different token PAN. Once the token is used (e.g., transmitted to host application 116), the token PAN may be marked as used in the microchip of payment card 110.

Payment card 110 may use a different PAN sequence number to differentiate the token PAN from previously generated tokens for different devices. For example, payment card 110 may store a single token PAN and transmit the same token PAN during each tokenization process. In addition to the token PAN, payment card 110 may output a PAN sequence number. The PAN sequence number may differentiate each tokenization process. For example, payment card 110 may generate a different PAN sequence number for each tokenization process. Thus, the PAN sequence number may be used to differentiate the digital wallets.

In addition to generating a token PAN, payment card may generate an account specific key. The account specific key may be a triple data encryption standard (3DES) or an advanced encryption standard (AES) key. The account specific key may be derived/or generated for a given PAN. The account specific key may be identified by a derivation key index within the issuing/authorizing host systems. In some aspects, the account specific key can also be derived following a proprietary algorithm or a defined algorithm. In some aspects, a length of the account specific key may be 16 bytes.

At 508, payment card 110 may update a value of a tokenization counter. For example, payment card 110 may increment the value of the tokenization counter for each tokenization process. Thus, payment card 110 may maintain the total number of tokenization process done using payment card 110. In addition, payment card 110 may accumulate all counters (e.g., the application transaction counter) and prepare a counter payload. Payment card 110 may also generate and transmit records and a record data payload (e.g., records of transactions made).

At 510, payment card 110 may transmit to the user device the tokenization data.

It is to be appreciated that not all steps may be needed to perform the disclosure provided herein. Further, some of the steps may be performed simultaneously, or in a different order than shown in FIG. 5, as will be understood be a person of ordinary skill in the art.

### Components of the System

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof. For example, the method steps of FIGS. 4 and 5 may be implemented via computer system 600.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method comprising:
initiating, using one or more processors of a user device and in an offline environment without connecting to a server, a tokenization transaction with a payment card;
acquiring, from the payment card and using the one or more processors, a token primary account number (PAN), an account specific key, and tokenization data associated with the tokenization transaction initiated by the user device; and
storing, in a digital wallet of the user device, an association between the token PAN and a digitized version of the payment card.

2. The method of claim 1, further comprising:
prior to acquiring the token PAN, the account specific key, and the tokenization data, mutually authenticating the user device and the payment card with one another.

3. The method of claim 1, wherein initiating the tokenization transaction comprises:
establishing a communication channel between the user device and the payment card.

4. The method of claim 3, wherein the communication channel is established via near field communication.

5. The method of claim 3, further comprising:
establishing an additional communication channel with the digital wallet.

6. The method of claim 1, wherein the tokenization data further comprises a PAN sequence number; and
wherein the PAN sequence number is generated by the payment card.

7. The method of claim 1, wherein a plurality of token PANs are stored on a microchip of the payment card; and
wherein the token PAN is selected from the plurality of token PANs.

8. The method of claim 1, wherein the account specific key is generated by a microchip of the payment card.

9. A payment card, comprising:
a microchip configured to:
receive a request for a tokenization transaction from a user device, wherein the request is sent in an offline environment without connecting to a server;
in response to receiving the tokenization transaction, generate tokenization data, wherein the tokenization data comprises at least a token primary account number (PAN) and an account specific key; and
transmit to the user device the tokenization data.

10. The payment card of claim 9, wherein the microchip is further configured to:
prior to generating the tokenization data, authenticate the user device.

11. The payment card of claim 10, wherein to authenticate the user device the microchip is further configured to:
perform a validation process using a common key with the user device, wherein the common key is provided by an issuer system of the payment card to the user device.

12. The payment card of claim 9, wherein the microchip is further configured to:
update a value of a tokenization counter in response to generating the tokenization data.

13. The payment card of claim 9, wherein the microchip is further configured to:
store a plurality of token PANs; and
select the token PAN from the plurality of token PANs.

14. The payment card of claim 9, wherein the microchip is further configured to:
generate a PAN sequence number, wherein the PAN sequence number is a unique identifier associated with each request for a tokenization transaction.

15. The payment card of claim 14, wherein the microchip is further configured to:
generate the account specific key based on the token PAN and the PAN sequence number.

16. The payment card of claim 9, wherein the tokenization data further comprises an application transaction counter and an offline data authentication key.

17. A system, comprising:
a memory; and
at least one processor coupled to the memory and configured to:
initiate a tokenization transaction with a payment card in an offline environment and without connecting to a server;
acquire, from the payment card, a token primary account number (PAN), an account specific key, and tokenization data associated with the tokenization transaction initiated by the user device; and
store, in a digital wallet of the user device, an association between the token PAN and a digitized version of the payment card.

18. The system of claim 17, wherein the at least one processor is further configured to:
prior to acquiring the token primary account number, mutually authenticate the user device and the payment card with one another.

19. The system of claim 17, wherein to initiate the tokenization transaction the at least one processor is further configured to:
establish a communication channel between the user device and the payment card.

20. The system of claim 19, wherein the communication channel is established via near field communication.
